(19) United States
(12) Patent Application Publication
(10) Pub. No.: US 2025/0228224 A1
(43) Pub. Date: Jul. 17, 2025

(54) METHOD OF CONTROLLING ROTATION SPEED OF DRIVE MOTOR OF ELECTRIC FISHING REEL

(71) Applicant: GLOBERIDE, Inc., Higashikurume-shi (JP)

(72) Inventor: Keisuke MATSUNO, Higashikurume-shi (JP)

(73) Assignee: GLOBERIDE, Inc., Higashikurume-shi (JP)

(21) Appl. No.: 18/903,668

(22) Filed: Oct. 1, 2024

(30) Foreign Application Priority Data
Jan. 17, 2024 (JP) 2024-005243

(51) Int. Cl. A01K 89/017

(52) U.S. Cl. CPC A01K 89/017

(57) ABSTRACT

A method of controlling a drive motor rotation speed including a drive motor which rotationally drives a spool and control unit controlling the drive motor rotation speed and that can set the drive motor rotation speed by main and controller side operation members in a controller separate from an electric fishing reel. The control unit executes, when the drive motor is rotationally driven at operation positions of the main body side and controller side operation members, catch-up control processing of controlling the rotation speed of the drive motor in such a way that, if a user operates the other one of the main body side operation member and the controller side operation member to a speed position at which a rotation speed thereof catches up with the rotation speed of the drive motor, the rotation speed of the drive motor is thereafter controlled by the operation of this operation member.

### CROSS-REFERENCE TO RELATED APPLICATION

This application claims priority under 35 U.S.C. § 119 to Japanese Patent Application No. 2024-005243 filed on Jan. 17, 2024 in the Japanese Patent Office, the entire contents of each hereby incorporated by reference.

### BACKGROUND OF THE INVENTION

### 1. Technical Field

The present invention relates to an electric fishing reel in which a fishing line is wound around a spool by output from a drive motor supported on a reel main body, and more specifically, relates to a method of controlling a rotation speed of the drive motor of the electric fishing reel comprising a controller capable of remotely operating a rotation speed of the drive motor.

### 2. Description of the Related Art

For example, as disclosed in JP 2005-218354 A, an electric fishing reel has been heretofore known in which a rotation speed of a drive motor for driving a spool can be adjusted using both an operation member on a reel main body side and an operation member on a controller side that is capable of remote operation. Transmission/reception units are respectively provided on sides of the controller and the reel main body so as to enable bidirectional communication, and a housing of the controller is provided with a button-type operation switch that transmits an operation signal to the reel main body side and a display device that displays information indicating an operation state from the reel main body side.

According to the electric fishing reel described above, a fishing person can adjust (set) the rotation speed of the drive motor by operating the controller at hand even at a position away from the electric fishing reel.

### SUMMARY OF THE INVENTION

On the other hand, although the controller disclosed in JP 2005-218354 A described above can remotely operate the rotation speed adjustment of the drive motor of the electric fishing reel, it cannot be said that the controller is sufficiently user-friendly. For example, when an attempt is made to adjust the motor output by the operation member (operation switch) on the controller side in a state where the motor output is adjusted by the operation member on the reel main body side, there is a problem that the rotation speed of the motor suddenly changes, the usability as a controller is poor, and the output of the drive motor is difficult to adjust. Although it is conceivable to adjust the output of the drive motor by switching the operation member on the reel main body side and the operation member on the controller side, JP 2005-218354 A does not disclose any method for smoothly performing such an operation mode.

The present invention has been made in view of the above-described problems of the prior art, and it is an object of the present invention to provide a speed control method of a drive motor capable of smoothly adjusting output of the drive motor by an operation member on a side used by a user when adjusting a rotation speed of the drive motor of an electric fishing reel using a main body side operation member and a controller side operation member that is capable of remote operation.

In order to achieve the object described above, the present invention provides a method of controlling a rotation speed of a drive motor of an electric fishing reel that is capable of setting a rotation speed of the drive motor of the electric fishing reel by both a main body side operation member provided in a reel main body and a controller side operation member provided in a controller separate from the electric fishing reel, the method being characterized in that
the drive motor is a motor that rotationally drives a spool provided in the reel main body,
the reel main body comprises a control unit that controls the rotation speed of the drive motor, and
the control unit executes,
in a state where the drive motor is rotationally driven at one of an operation position of the main body side operation member and an operation position of the controller side operation member,
catch-up control processing of controlling the rotation speed of the drive motor in such a way that, if a user operates the other one of the main body side operation member and the controller side operation member to a speed position at which a rotation speed thereof catches up with the rotation speed of the drive motor, the rotation speed of the drive motor is thereafter controlled by the operation of the other one of the main body side operation member and the controller side operation member.

According to the above-described method of controlling a rotation speed of a drive motor, in a state where the drive motor is rotationally controlled by one of the main body side operation member provided on the reel main body and the controller side operation member to be remotely operated, when the other operation member is operated, the rotation speed cannot be adjusted by this operation member unless its rotation speed catches up with the current rotation speed of the drive motor. In other words, since both the operation members do not interlock with each other, when the other operation member is operated, the rotation speed of the drive motor does not change suddenly, thus making it possible to control the drive motor of the electric fishing reel with good usability.

Note that, the reel main body side operation member and the controller side operation member described above are preferably of a lever type or a dial type (rotating body) that is rotationally driven at an angle in a certain range so that the rotation speed of the drive motor is understandable. In other words, it is preferable that the output of the drive motor can be adjusted according to the amount of rotation of the rotating body.

As described above, according to the present invention, it is possible to obtain a speed control method capable of smoothly adjusting the output of the drive motor by the operation member on the side used by the user when the drive speed of the drive motor of the electric fishing reel is adjusted using the main body side operation member provided on the reel and the controller side operation member capable of remote operation.

### BRIEF DESCRIPTION OF THE DRAWINGS

FIG. 1 is a view illustrating an embodiment of an electric fishing reel and a controller according to the present invention;

FIG. 2 is a block diagram illustrating a control system on a reel main body side and a control system on a controller side;

FIG. 3 is an enlarged view illustrating a main body side operation member provided in the reel main body and a remote operation member provided in the controller; and

FIG. 4 is a flowchart illustrating an example of a method of controlling a rotation speed of a drive motor according to the present invention.

### DETAILED DESCRIPTION

Hereinafter, an embodiment of a method of controlling a rotation speed of a drive motor of an electric fishing reel according to the present invention will be described with reference to the accompanying drawings.

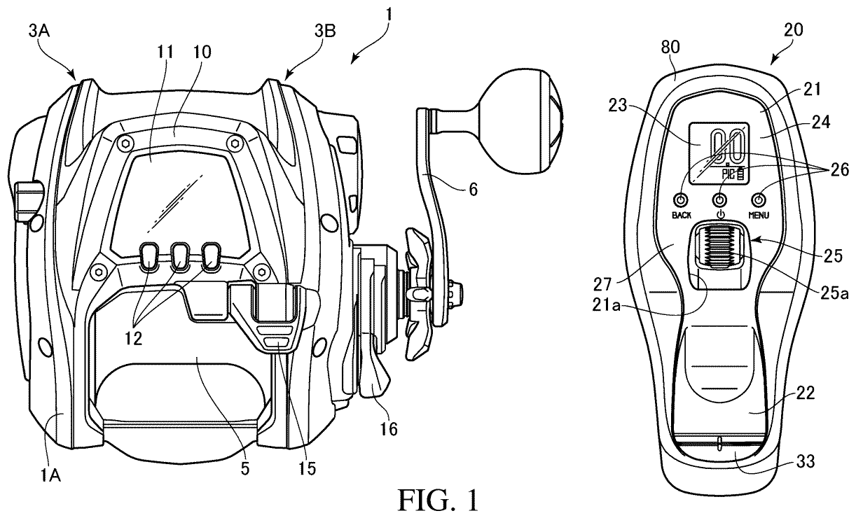

First, a configuration of an electric fishing reel and a configuration of a controller of the present embodiment will be described with reference to FIG. 1.

The electric fishing reel and the controller according to the present embodiment are configured to be able to remotely adjust the driving state (rotation speed) of a drive motor of the electric fishing reel easily by operating the controller under a situation where a fishing person cannot operate the electric fishing reel directly or under a situation where the fishing person is away from the electric fishing reel, such as a state where the fishing person is away from a position at which a fishing rod is installed on a rod hook, a state where the fishing person (captain) who operates a fishing boat is in a cabin while leaving the fishing rod behind, and a state where the fishing person (fisherman) is performing another operation while leaving the fishing rod behind.

Therefore, the controller may be held by the fishing person at all times, or may be placed on another object (e.g. an article) such as a ship edge, a seat, or a cooler box. Alternatively, the controller may be provided with a strap or the like and used by being hooked on a structure of a ship (columns, protrusions, etc.).

As illustrated in FIG. 1, a reel main body 1A of an electric fishing reel 1 of the present embodiment comprises left and right side plates 3A and 3B, and a spool 5 around which a fishing line is wound is rotatably supported between the left and right side plates 3A and 3B.

A manual handlebar 6 through which a winding operation is performed is provided on one side plate (right side plate 3B) side of the left and right side plates, and is configured to enable the winding operation of the spool 5 via a known power transmission mechanism. Further, in the present embodiment, a drive motor (not illustrated) is held between the left and right side plates 3A and 3B at a position on the front side of the spool 5. The spool 5 is rotationally driven in a fishing line winding direction by the winding operation of the manual handlebar 6 and the rotational drive of the drive motor.

A box-shaped control case 10 housing a control unit that controls the drive motor is disposed above the spool 5 located between the left and right side plates 3A and 3B. A display device (a liquid crystal display unit) 11 for displaying a line length (water depth), time, a mode, and the like, and button type (or touch type) operation buttons 12 for setting various modes are arranged on a front surface side of the control case 10.

Further, a main body side operation member 15 that adjusts output of the drive motor is disposed in a rear portion of the control case 10. The main body side operation member 15 of the present embodiment has a lever-shaped form (operation lever) provided on a support shaft rotatably supported on a right side plate side at a position behind the control case 10, and is configured to adjust the output of the drive motor by rotating the main body side operation member 15 in the front-rear direction.

In addition, a known clutch mechanism that switches the spool 5 to a fishing line winding state/free rotation state is arranged on one side plate (right side plate 3B) side. This clutch mechanism has a function of connecting and disconnecting power transmission from the manual handlebar 6 and the drive motor to the spool 5, and is configured to switch from a clutch-ON state to a clutch-OFF state by a clutch operation member 16 that is disposed on the right side plate 3B side so as to be displaceable in the front-rear direction. In this case, when the clutch operation member 16 is rotated forward in the clutch-ON state (power transmission state) illustrated in FIG. 1, the clutch mechanism switches to the clutch-OFF state.

Note that, returning from the clutch-OFF state to the clutch-ON state can be automatically performed by an operation of the clutch operation member 16 in the reverse direction, the winding operation of the manual handlebar 6, and driving of the drive motor, for example.

As is known, the electric fishing reel 1 comprising the above-described configuration is mounted on a fishing rod, and is ready for use by fixing the fishing rod to a rod hook member (rod keeper) fixed to a ship edge. Specifically, a rig is cast in the sea with the clutch mechanism turned off, and the clutch is turned on when the rig reaches a predetermined shelf (the clutch is turned on automatically or manually). When a fish is caught in this state, the main body side operation member 15 is rotated to drive the drive motor while adjusting the speed, thus winding a fishing line around the spool 5. In this case, in the electric fishing reel 1, as described above, even when the fishing person is away from the position of the fishing rod, it is possible to remotely operate the drive motor by a controller 20.

The controller 20 comprises a housing 21 provided with a grip portion 22 that can be gripped with one hand and a display device (liquid crystal display unit) 23 that is visible when a user grips the grip portion 22.

In addition, the housing 21 is provided with a controller side operation member 25 capable of adjusting the output of the drive motor on the reel main body 1A side with a thumb in a state where the user grips the grip portion 22.

The display device 23 displays the same information as information displayed on the display device 11 on the reel main body side, including water depth information. Besides the above information, it is also possible to display time (current time, winding time, etc.), a communication radio wave state, and the like, and also possible to display individual information on the controller side, such as a remaining battery level and a motor output value of an operation dial. In addition, the housing 21 is provided with operation buttons 26 besides the controller side operation member 25. These operation buttons 26 can be arranged at any position of the housing 21, and in the present embodiment, the multiple operation buttons are arranged between the display device 23 and the controller side operation member 25. The operation buttons 26 of the present embodiment comprise an ON/OFF button of the controller, a menu button for setting various menus, and a Back button used when canceling (returning) in the menu.

The controller side operation member 25 of the present embodiment is configured as a rotating body. Specifically, the operation member is configured in a dial-type shape (operation dial) capable of rolling operation by pressing it with a thumb (hereinafter also referred to as an operation dial 25). The operation dial 25 comprises an operating part 25a having a substantially columnar shape at the center of a support shaft, and both sides of the support shaft are rotatably supported with respect to the housing 21. The operating part 25a is exposed from a substantially rectangular opening 21a formed in a central portion of the housing 21, and is rotationally driven by pushing up/pushing down (sliding) the operating part 25a along the up-down direction while pressing it with a thumb.

Note that, for example, the operating part 25a preferably has protrusions and depressions such as a large number of grooves and knurls along the axial direction as in the present embodiment so as to increase the frictional force and not to slip during operation.

In addition, since the controller 20 is used on a ship, the controller may collide with other objects or seawater may enter inside it. For this reason, it is preferable that at least a cover member 80 from which the display device 23 and the controller side operation member 25 are exposed be mounted on the housing 21.

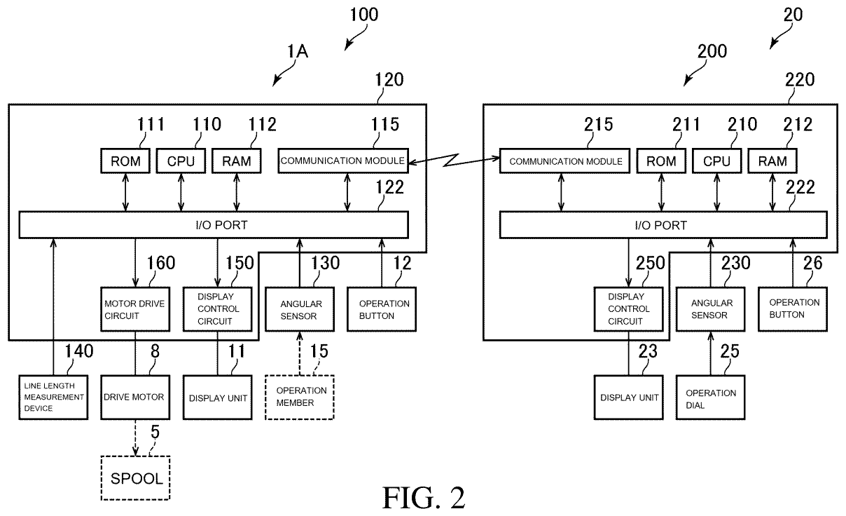

Next, a control system on the reel main body 1A side and a control system on the controller 20 side will be described with reference to a block diagram of FIG. 2.

A control unit 100 accommodated in the control case 10 of the reel main body 1A comprises a control substrate (microcomputer) 120 on which a central processing unit (CPU) 110 that controls the operation of the electric fishing reel, a read only memory (ROM) 111, a random access memory (RAM) 112 as a temporary storage area, a communication module 115 that transmits and receives various information signals to and from the controller 20, and the like are mounted.

The communication module 115 may comprise any system as long as it is capable of transmitting and receiving information at a short distance on the ship, and Bluetooth (registered trademark) is used, for example.

The control substrate 120 is configured to transmit and receive signals to and from each actuating element via an I/O port 122 and control the operation of each actuating element.

Operation signals of detection means, which is configured to detect the amount of operation of the operation member 15, specifically an angular sensor 130 that outputs an operation position signal according to the operation angle of the operation member 15, a line length measurement device 140 that is capable of detecting the amount of fishing line, wound around the spool 5, fed off, and the operation buttons 12 that are arranged on the control case 10 are configured to be transmitted and received to and from the control substrate 120.

A display control circuit 150 that causes the display device 11 to display various kinds of information and a motor drive circuit 160 that continuously increases and decreases the output of the drive motor 8 from a stop state to a high output value are mounted on the control substrate 120. The CPU 110 has a function of controlling each actuating element above to control the entire electric fishing reel by executing a predetermined program stored in the ROM 111 and supplying a control signal generated in response thereto to each actuating element via the I/O port 122.

The ROM 111 stores various programs to be executed by the CPU 110. In this case, in the present embodiment, a control program for detecting a rotation operation (the amount of operation) of the operation member 15 on the reel main body side, a rotation operation (the amount of operation) of the operation member 25 on the controller side, and a rotation speed of the drive motor 8 to control the rotation speed of the drive motor 8 is stored so as to execute a procedure of a flowchart to be described later.

Besides the above control program, the ROM 111 also stores, for example, data (such as an arithmetic program for measuring a line length based on a detection signal input from the line length measurement device 140, a variable control table for specifying an operation angle of the operation member 15 and a duty ratio for varying a rotation speed of the drive motor 8 correspondingly, and image display data for displaying an image such as a character and a number on the display device 11) required for control processing.

The RAM 112 includes a work area and has a function of temporarily storing processing procedures, data, and the like when the program is operating.

The operation buttons 12 accept various kinds of information from the fishing person, such as depth information for stopping the cast rig at a desired depth, and output range setting information for changing the variable range of the output of the drive motor 8. Further, when the spool 5 is rotationally driven to feed/wind a fishing line, the line length measurement device 140 detects the actual amount of rotation and the rotation direction by, for example, a magnet attached to a rotating portion and a magnetic sensor that detects the magnet, and generates a detection signal thereof.

The motor drive circuit 160 has a function of driving and controlling the drive motor 8 that rotationally drives the spool 5. Specifically, the motor drive circuit 160 variably controls the energization time ratio (duty ratio) of the drive current on the drive motor based on a control signal (PWM signal; pulse width modulation signal) from the CPU 110, for example, to perform an increase/decrease adjustment on the drive motor 8 continuously between the stopped state (OFF state) and the high-speed rotation state (Max state). Note that, the CPU 110 outputs a control signal related to the duty ratio set for each angle based on a detection signal by the angular sensor that detects the actual amount of operation from an initial position (OFF position) of the main body side operation member 15.

The display control circuit 150 is driven based on control of the CPU 110, and has a function of causing the display device 11 to display, to the fishing person, various kinds of information such as the amount of fishing line currently fed out, the time since the casting of the rig, the driving speed of the drive motor 8 (may be displayed by an indicator), an operation method, and a message.

The angular sensor 130 that detects the operation rotation angle of the main body side operation member 15 has only to have a function of generating a signal corresponding to the operation angle of the main body side operation member 15. For example, angular sensors of various structures can be employed, such as one comprising a potentiometer that outputs a change in resistance value according to the amount of operation of the main body side operation member 15, one comprising an encoder that generates a pulse according to the amount of operation of the main body side operation member 15, and one incorporating a Hall sensor that detects a change in magnetic field according to the rotation angle of the main body side operation member 15.

A control unit 200, which is a control system on the controller 20 side, is housed in the housing 21 and comprises a control substrate (microcomputer) 220 on which components such as a central processing unit (CPU) 210 that controls the operation of the controller 20, a read only memory (ROM) 211 that stores a transmission/reception program for transmitting/receiving information to/from the reel main body 1A, various kinds of setting information (control table), and the like, a random access memory (RAM) 212 as a temporary storage area, and a communication module 215 that transmits/receives various information signals to/from the reel main body 1A are mounted. In addition, a display control circuit 250 that causes the display device 23 to display various kinds of information is mounted on the control substrate 220.

Bluetooth (registered trademark) is used as a communication module 215 as in the communication module 115 on the reel main body side.

The control substrate 220 is configured to transmit and receive signals to and from each actuating element via an I/O port 222 and control the operation thereof. The control substrate 220 transmits and receives signals to/from an angular sensor 230 that detects the amount of operation of the controller side operation member 25 (hereinafter also referred to as the operation dial 25) and the operation buttons 26 arranged in the housing 21.

The CPU 210 has a function of controlling each actuating element above to control the controller 20 by executing a predetermined program stored in the ROM 211 and supplying a control signal generated in response thereto to each actuating element via the I/O port 222.

Note that, the angular sensor 230 for detecting the operation rotation angle of the operation dial 25 has the same configuration as the angular sensor 130 on the reel main body side, which makes it easier to synchronize a drive signal generated according to the operation angle of the main body side operation member 15 that drives the drive motor 8 on the reel main body 1A side and a drive signal generated according to the operation angle of the operation dial 25 on the controller 20 side.

According to the above configuration, information is transmitted and received between the reel main body 1A side and the controller 20 side via the communication modules 115 and 215. This makes it possible to display various kinds of information (for example, water depth information), displayed on the display device 11 on the reel main body 1A side, on the display device 23 on the controller 20 side, and perform control to drive the drive motor 8 on the reel main body 1A side at the same rotation speed as the rotation operation of the main body side operation member 15 by the rotation operation of the operation dial 25 on the controller 20 side.

As described above, the operation dial 25 is capable of remote operation with the same function as the main body side operation member 15. In other words, by pressing a thumb against the operation dial 25 while gripping the grip portion 22 and rotating the operation dial in this state, it is possible to remotely operate acceleration, deceleration, and stop of the drive motor of the reel main body 1A. As a result, the output of the drive motor on the reel main body side can be adjusted only by the amount of operation of the thumb (sense of the finger) of one hand without looking at the hand, and the rotation control of the drive motor can be performed in a reliable gripping state by gripping the grip portion 22.

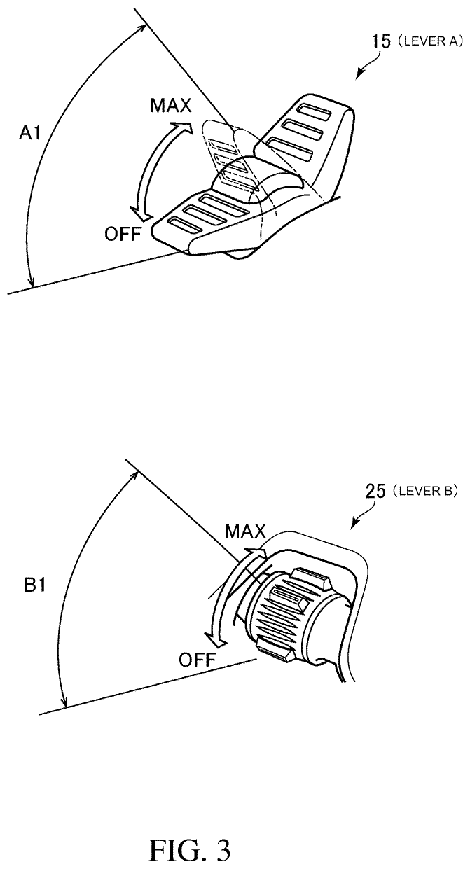

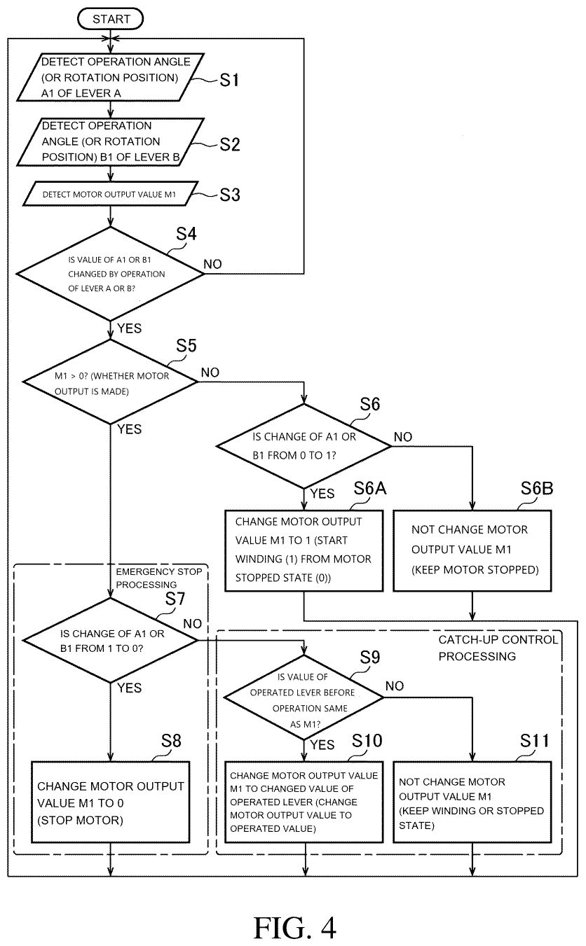

Next, with respect to an operation mode of the reel main body side operation member 15 illustrated in FIG. 3 and the controller side operation member (operation dial) 25 provided in the controller 20, a procedure example of a method of controlling the rotation speed of the drive motor 8 executed by a control unit 100 will be described with reference to a flowchart in FIG. 4.

In this case, an operation angle of the main body side operation member 15 illustrated in FIG. 3 is indicated by A1, and is referred to as a lever A in the flowchart of FIG. 4. In addition, an operation angle of the controller side operation member 25 illustrated in FIG. 3 is indicated by B1, and is referred to as a lever B in the flowchart of FIG. 4. Further, the rotation speed (output value) of the drive motor 8 is indicated by M1.

In the present embodiment, the operation angle A1 of the lever A, the operation angle B1 of the lever B, and their output value M1 of the drive motor 8 are independent, and the rotation speed of the drive motor 8 is controlled by the operation position (rotation position) of each of the levers A and B. In addition, the rotation speed of the drive motor 8 is controlled by a digital variable value, including an integer from 0 to X, according to the amount of operation of the lever A or the lever B. For this variable value, in the conventional electric fishing reel, the MAX value which is X is set to 31, but any value may be set as the MAX value. Thus, the rotation positions of the levers A and B are also identified with the same variable values as the variable values 0 to X of the rotation speed of the drive motor 8.

When the power supply on the reel main body side and the power supply on the controller side are turned on, the control unit 100 executes a series of procedures of the flowchart illustrated in FIG. 4.

First, the operation angle (rotation position) A1 of the lever A, the operation angle (rotation position) B1 of the lever B, and the motor output value M1 of the drive motor are detected (Steps S1 to S3). In these detection, it is detected whether the rotation position A1 or B1 is changed by the operation of the lever A or the lever B (Step S4).

In Step S4, if the rotation position A1 or B1 is not changed (Step S4; No), the processing of Steps S1 to S3 described above is iterated. On the other hand, if a change in the rotation position A1 or B1 is detected in Step S4 (Step S4; Yes), it is detected whether or not the motor output value M1 is output (Step S5).

If it is detected in Step S5 that the variable value of the motor output value M1 is 0 (Step S5; No (M1=0)) and if it is detected that the rotation position A1 or B1 is changed from 0 to 1, then the motor output value is changed to 1, and then the drive motor is driven (starts winding from the motor stopped state) by the operation of the lever on the side where the rotation position is changed from 0 to 1 (Step S6; Yes, and Step 6A).

For example, if it is detected that any of the levers is rotated from 0 in a state where the power supply on the reel main body side and the power supply on the controller side are turned on and if the motor output value of 1 is detected, then the rotation speed of the drive motor is controlled by the lever operation on the side where the above operation is performed. In other words, as in speed control of a general electric reel, the user can rotationally drive the drive motor by the lever operation of either the main body or the controller.

In addition, if the motor output value M1 is not in the output state in Step S5 (Step S5; No (M1=0)) and if the change of the rotation position A1 or B1 from 0 to 1 is not detected, the rotational drive of the drive motor is not executed (Step S6; No and Step 6B).

This corresponds to a state in which the levers A and B are not at 0 positions. For example, when fishing is actually performed, in a state where the drive motor is stopped by the ship edge stop function and the lever A or the lever B is not at the 0 position, the drive motor is kept stopped. Alternatively, when the power supply on the reel main body side and the power supply on the controller side are turned on in a state where the lever A or the lever B is not at the 0 position, the drive motor is not erroneously driven, and the drive motor cannot be driven by the lever unless the user returns the lever A or the lever B to the 0 position once (Step 6B, Steps S1 to S6, and Step 6A).

If the motor output value M1 is in the output state in Step S5 (Step S5; Yes) and if it is detected that the rotation position A1 or B1 is changed from 1 to 0, the rotational drive of the drive motor is stopped (Step S8). This is the processing executed when the user stops the drive motor, and includes normal stop processing of the drive motor and emergency stop processing. In this emergency stop processing, for example, when entanglement of yarn or the like occurs during winding of a fishing line and the drive motor is required to be urgently stopped, the drive motor is stopped by the operation of either the lever A or the lever B.

In addition, the control unit 100 executes catch-up control processing to be described below with respect to the operations of the lever A and the lever B. The catch-up control processing is processing of controlling the rotation speed of the drive motor in such a way that, in a state where the drive motor is rotationally driven at one of the rotation position of the lever A and the rotation position of the lever B, if the user rotates the other lever (the lever B when the lever A is rotationally driven and the lever A when the lever B is rotationally driven) so that its rotation speed catches up with the rotation speed of the drive motor currently rotationally driven, the rotation speed of the drive motor is thereafter controlled by the rotation operation of the other lever described above.

In a case where the above-described catch-up control processing is executed, both operation members (the lever A and the lever B) do not interlock with each other. Thus, when the other lever is operated, the rotation speed of the drive motor does not change suddenly, thus making it possible to realize a user-friendly electric fishing reel and controller. In other words, even if the other lever is operated, the drive motor cannot be rotationally driven by the other lever unless its operation position catches up with the rotation speed of the drive motor currently rotationally driven.

The above-described catch-up control processing is executed if the drive motor is in the output state (Step S5; Yes) and the change of the variable value from 1 to 0 is not detected (Step S7; No). Specifically, this is processing that enables the following. In a state where the drive motor is rotationally driven by one of the lever A and the lever B, if the operation is performed by the other lever and if it is determined that its rotation position (operation position) is the same as the current output value of the drive motor (Step S9), the drive motor is thereafter driven by the operation of the other lever (Step S9; Yes and Step S10).

Further, in this catch-up control processing, when the other lever is operated, if the rotation position (operation position) does not reach the current output value of the drive motor (Step S9; No), the output value of the drive motor is not changed even if the other lever is operated (Step S11). In other words, in a situation in which the operation of the other lever cannot catch up with the rotation speed of the drive motor currently rotationally driven, the rotation speed of the drive motor currently rotationally driven is kept as it is.

Here, with reference to the following Table 1, in the electric fishing reel 1 that executes the above-described catch-up control processing, an operation angle position of the lever A (the main body side operation member 15), an operation angle position of the lever B (the controller side operation member 25) of the controller 20, an output state of the drive motor, and processing executed when either the lever A or the lever B is operated in a case where the drive motor is in a predetermined output state will be exemplified.

TABLE 1

| | ANGLE OF | ANGLE OF | STATE OF | | |
|---|---|---|---|---|---|
| CASE | LEVER A | LEVER B | MOTOR | OPERATION CONTENTS | OUTPUT |
| 1 | 0 | 0 | STOPPED | B IS CHANGED FROM 0 TO | MOTOR IS DRIVEN AT 15 |
| | | | | 15 | |
| 2 | 0 | 15 | WINDING AT 15 | A IS CHANGED FROM 0 TO | MOTOR IS KEPT DRIVEN |
| | | | | 14 | AT 15 |
| 3 | 14 | 15 | WINDING AT 15 | A IS CHANGED FROM 14 | MOTOR IS KEPT DRIVEN |
| | | | | TO 8 | AT 15 |
| 4 | 14 | 15 | WINDING AT 15 | A IS CHANGED FROM 14 | MOTOR IS KEPT DRIVEN |
| | | | | TO 15 | AT 15 |
| 5 | 15 | 15 | WINDING AT 15 | A IS CHANGED FROM 15 | MOTOR IS DRIVEN AT 25 |
| | | | | TO 25 | |
| 6 | 25 | 15 | WINDING AT 25 | STANDBY WITHOUT | MOTOR IS DRIVEN AT 25 |
| | | | | OPERATION | SHIP EDGE STOP |
| 7 | 25 | 15 | STOPPED | RIG IS BEING CAST | KEPT STOPPED |
| 8 | 25 | 10 | STOPPED | B IS CHANGED FROM 10 | MOTOR IS DRIVEN AT 8 |
| | | | | TO 0 AND THEN TO 8 | |
| 9 | 25 | 16 | STOPPED | B IS CHANGED FROM 16 | KEPT STOPPED |
| | | | | TO 5 | |
| 10 | 25 | 16 | STOPPED | A IS CHANGED FROM 25 | KEPT STOPPED |
| | | | | TO 16 | |

Case 1 in Table 1 is a state in which the angle of the lever A and the angle of the lever B are both 0 (corresponding to a variable value 0 in the driving of the motor) and the drive motor is stopped. In this state, when the lever B is rotated to a variable value 15, for example, the output of the drive motor increases according to the operation angle. In addition, in this Case 1, the same applies when the lever A is rotated.
Case 2 in Table 1 is a state in which the angle of the lever A is 0, the angle of the lever B is a variable value 15, and the drive motor performs the winding processing with the variable value 15. In this state, even if the lever A is rotated to a variable value 14, for example, the condition of executing the catch-up control processing described above is not satisfied, and thus the drive motor is kept driven with the variable value 15.
Case 3 in Table 1 is a state in which the angle of the lever A is a variable value 14, the angle of the lever B is a variable value 15, and the drive motor performs the winding processing with the variable value 15. In this state, even if the lever A is rotated from the variable value 14 to the lower speed side, for example, the condition of executing the catch-up control processing described above is not satisfied, and thus the drive motor is kept driven with the variable value 15.
Case 4 in Table 1 is a state in which the angle of the lever A is a variable value 14, the angle of the lever B is a variable value 15, and the drive motor performs the winding processing with the variable value 15. In this state, when the lever A is rotated from the variable value 14 to the variable value 15, for example, the drive motor kept is driven with the variable value 15. Thereafter, when the lever A is rotated to the higher speed side than the variable value 15, the condition of executing the catch-up control processing is satisfied, and thus the speed of the drive motor can be adjusted by the lever A (the operation right shifts to the lever A).
Case 5 in Table 1 is a state in which the angle of the lever A is a variable value 15, the angle of the lever B is a variable value 15, and the drive motor performs the winding processing with the variable value 15. In this state, when the lever A is rotated to, for example, a variable value 25, the drive motor is driven to accelerate according to the rotation operation of the lever A, and thereafter the speed is adjusted by the lever A.
Case 6 in Table 1 is a state in which the angle of the lever A is a variable value 25, the angle of the lever B is a variable value 15, and the drive motor performs the winding processing with the variable value 25. In this state, the drive motor keeps performing the winding process with the variable value 25 unless either the lever A or the lever B is operated. Note that, when the amount of fishing line wound reaches a predetermined position, the drive motor is stopped for the ship edge stop as in the conventional case.
Case 7 in Table 1 is a state in which the angle of the lever A is a variable value 25, the angle of the lever B is a variable value 15, and the drive motor is stopped such as clutch-off. In this state, the drive motor is kept stopped unless either the lever A or the lever B is operated. Note that, in the clutch-off state, the drive motor may be controlled not to be driven even if the lever A or the lever B is rotationally operated.
Case 8 in Table 1 is a state in which the angle of the lever A is a variable value 25, the angle of the lever B is a variable value 10, and the drive motor is stopped. In this state, once the lever B (which may be the lever A) is returned to 0, thereafter, the drive motor can be driven by the operation of the lever B returned to 0.
Cases 9 and 10 in Table 1 are each a state in which the angle of the lever A is a variable value 25, the angle of the lever B is a variable value 16, and the drive motor is stopped. In this state, irrespective of which of the lever B and the lever A is operated, the drive motor maintains the stopped state. Note that, once any one of the levers is returned to 0, thereafter, the drive motor can be driven by the operation of the lever returned to 0 (same as Case 8).

The catch-up control processing described above effectively functions, for example, when it is desired to finely adjust the output of the drive motor by observing the movement of the rod during winding of the spool in deep-sea fishing. In other words, the motor output does not greatly change and fine adjustment can be performed irrespective of which of the lever A and the lever B is operated during winding of the spool.

The embodiments of the present invention have been described above, but the present invention is not limited to the above embodiments and may be modified in various ways.

The catch-up control processing described above may be incorporated in a control unit provided in the main body of the electric fishing reel and may be integrated with the controller that remotely operates the drive motor. In other words, the present invention may be configured as the electric reel set with the controller. In this case, the operation member that rotationally operates the drive motor can be configured in a form other than the lever form and the dial form described above, and the shape and the operation form are not limited.

In addition, in the above-described embodiment, the example has been described in which the rotation of the drive motor is controlled by making one controller correspond to one electric fishing reel, but drive motors of respective multiple electric fishing reels may be controlled by one controller.

In this case, for example, three controller side operation members may be installed in the controller, and each controller side operation member may be associated with the corresponding electric fishing reel by communication processing before the start of use.

In addition, one controller side operation member and three buttons capable of selecting reels may be separately installed in the controller, and each of the reel selection buttons may be associated with the corresponding electric fishing reel by communication processing before the start of use.

Further, in a case where the drive motors of the respective multiple electric fishing reels are controlled by one controller as described above, display contents displayed on the display device of the controller may interlock with a controller side operation member to be used (an operation member corresponding to each electric reel) or may interlock with a reel selection button. As a result, information on the electric reel controlling the drive motor by the controller can be displayed on the display device of the controller.

In addition, the controller 20 may be configured to be capable of remote operation other than the adjustment of the output of the drive motor of the reel main body. For example, various operations performed on the reel main body side, such as alarm setting (ON/OFF, tone, interval), screen display setting (two-stage display or the like), swinging/timer winding-up setting (motor time control), drive mode switching setting (winding-up setting at a constant speed), a float fishing mode, electronic drag sound, drag force adjustment, clutch ON/OFF switching operation, and gear ratio switching at the time of winding-up, may be performed on the controller side.

In addition, the rotation speed control of the drive motor may include processing other than the above-described catch-up control processing. Such control processing may be appropriately inserted in the flowchart illustrated in FIG. 4.

What is claimed is:

1. A method of controlling a rotation speed of a drive motor of an electric fishing reel that is capable of setting a rotation speed of the drive motor of the electric fishing reel by both a main body side operation member provided in a reel main body and a controller side operation member provided in a controller separate from the electric fishing reel, wherein
the drive motor is a motor that rotationally drives a spool provided in the reel main body, the reel main body comprises a control unit that controls the rotation speed of the drive motor, and
the control unit executes,
in a state where the drive motor is rotationally driven at one of an operation position of the main body side operation member and an operation position of the controller side operation member,
catch-up control processing of controlling the rotation speed of the drive motor in such a way that, if a user operates the other one of the main body side operation member and the controller side operation member to a speed position at which a rotation speed thereof catches up with the rotation speed of the drive motor, the rotation speed of the drive motor is thereafter controlled by the operation of the other one of the main body side operation member and the controller side operation member.

2. The method of controlling a rotation speed of a drive motor of an electric fishing reel according to claim 1, wherein
the rotation speed of the drive motor is controlled by a digital variable value, including an integer from 0 to X, according to an amount of operation of the main body side operation member or the controller side operation member, and
the control unit executes the catch-up control processing if a change of the variable value from 1 to 0 is not detected.

3. The method of controlling a rotation speed of a drive motor of an electric fishing reel according to claim 1, wherein the control unit executes stop processing of the drive motor if a change of a variable value from 1 to 0 by an operation of the main body side operation member or an operation of the controller side operation member is detected.

4. The method of controlling a rotation speed of a drive motor of an electric fishing reel according to claim 2, wherein, if the change of the variable value from 1 to 0 is not detected, the control unit maintains the rotation speed of the drive motor in a mode in which the operation of the other one of the main body side operation member and the controller side operation member does not catch up with the rotation speed of the drive motor currently rotationally driven.

5. The method of controlling a rotation speed of a drive motor of an electric fishing reel according to claim 2, wherein, if it is detected that the variable value is changed from 0 to 1 by an operation of the other one of the main body side operation member and the controller side operation member in a state where it is detected that the variable value is 0, the control unit thereafter controls the rotation speed of the drive motor by the operation of the other one of the main body side operation member and the controller side operation member.

6. The method of controlling a rotation speed of a drive motor of an electric fishing reel according to claim 2, wherein, if it is not detected that the variable value is changed from 0 to 1 by an operation of the main body side operation member or an operation of the controller side operation member in a state where it is detected that the variable value is 0, the control unit does not rotationally drive the drive motor.

7. An electric reel set with a controller comprising:
an electric fishing reel comprising a drive motor that rotationally drives a spool, a control unit that controls a rotation speed of the drive motor, and a main body side operation member that controls the rotation speed of the drive motor; and
a controller configured to remotely control the rotation speed of the drive motor by a controller side operation member, wherein
the control unit executes,
in a state where the drive motor is rotationally driven at one of an operation position of the main body side operation member and an operation position of the controller side operation member,
catch-up control processing of controlling the rotation speed of the drive motor in such a way that, if a user operates the other one of the main body side operation member and the controller side operation member to a speed position at which a rotation speed thereof catches up with the rotation speed of the drive motor, the rotation speed of the drive motor is thereafter controlled by the operation of the other one of the main body side operation member and the controller side operation member.
